(19) United States
(12) Patent Application Publication
(10) Pub. No.: US 2026/0125555 A1
(43) Pub. Date: May 7, 2026

(54) PCL/DCP BASED FREE STANDING THERMO-RESPONSIVE TWO WAY SHAPE MEMORY POLYMER GRIPPER

(71) Applicant: Khalifa University of Science and Technology, Abu Dhabi (AE)

(72) Inventors: Kamran A. Khan, Abu Dhabi (AE); Aamna Hameed, Abu Dhabi (AE)

(21) Appl. No.: 18/937,543

(22) Filed: Nov. 5, 2024

(51) Int. Cl. C08L 67/04; B29C 61/06; B29K 67/00; B29K 105/24; C08K 5/14

(52) U.S. Cl. CPC C08L 67/04; C08K 5/14; B29C 61/06; B29K 2067/04; B29K 2105/24; B29K 2995/0048; C08L 2203/30; C08L 2312/00

(57) ABSTRACT

Provided herein is a thermoresponsive two-way shape memory polymer comprising a crosslinking agent, a thermoplastic polyester, and a low-stiffness elastomer, wherein the crosslinking agent and the thermoplastic polyester are positioned internal to the elastomer. Also provided herein is a method of producing an actuator from a thermoresponsive two-way shape memory polymer comprising reacting a crosslinking agent with a thermoplastic polyester to produce a polymer and reacting the polymer with a low-stiffness elastomer to produce the two-way thermoresponsive shape memory polymer. The actuator is transitioned from a first position to a second position by application of a high temperature, and wherein the actuator is reversable from the second position back to the first position under application of a low temperature.

### BACKGROUND OF THE INVENTION

Recently, smart materials such as shape memory polymers (SMPs) have attracted great attention for their ability to undergo controlled shape changes in response to external stimuli, typically temperature variations. This remote triggering capability enables precise actuation and deformation on demand, opening new possibilities for applications that require shape adaptability, such as biomedical devices, robotic systems, and deployable space structures. The unique combination of mechanical robustness, low weight, case of fabrication, and remote shape-changing capabilities positions SMPs as promising materials for the development of innovative solutions across various industries.

A one-way SMP demonstrating one way shape memory effect (SME) is the simplest form, where the polymer is initially deformed at a temperature above its switching point (e.g., melting or glass transition temperature). This temporary shape is then fixed by cooling the material to room temperature. To recover its permanent shape, the SMP is reheated, completing one full shape memory cycle. However, a significant limitation of the one-way SME is that additional programming steps are required to initiate subsequent cycles, which can be impractical for certain applications. Thus, a two-way shape memory polymer that is capable of cycling from its initial state to a deformed state and subsequently back, without additional programming steps, is highly desirable.

### BRIEF SUMMARY OF THE INVENTION

Covered embodiments of the present disclosure are defined by the claims, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings and each claim.

A shape memory polymer can include a crosslinking agent, a thermoplastic polyester, and a low-stiffness elastomer. The crosslinking agent and the thermoplastic polyester may be positioned internal to the elastomer.

In some embodiments, the crosslinking agent may be dicumyl peroxide and the thermoplastic polyester may be polycaprolactone. In some embodiments, the low stiffness elastomer may include any one of natural rubbers, polyurethanes, polybutadienes, silicones, neoprene, or any combination thereof.

In some embodiments, the thermoresponsive two-way shape memory polymer may include an actuation magnitude of greater than 7.0%. In some embodiments, the thermoresponsive two-way shape memory polymer can include a strain recovery of at least 49% when thermally cycled.

In some embodiments, the thermoresponsive two-way shape memory polymer may be configured to be a freestanding two-way SMP gripper device.

Described herein is a gripping device comprising the thermoresponsive two-way shape memory polymer.

A method of producing an actuator can include reacting a crosslinking agent with a thermoplastic polyester to produce a polymer. The polymer may be reacted with a low-stiffness elastomer to produce the two-way thermoresponsive shape memory polymer. The actuator may be transitioned from a first position to a second position by application of a high temperature. In some embodiments, the actuator may be reversible from the second position back to the first position under application of a low temperature.

In some embodiments, the crosslinking agent may be dicumyl peroxide. In some embodiments, the thermoplastic polyester may be a polycaprolactone. In yet other embodiments, the low-stiffness elastomer can include natural rubbers, polyurethanes, polybutadienes, silicones, neoprene, or any combination thereof.

In some embodiments, the two-way thermoresponsive shape memory polymer may include an actuation magnitude of greater than 7.0%. In some embodiments, the two-way thermoresponsive shape memory polymer comprises a strain recovery of at least 49% when thermally cycled.

A method of actuating a two-way thermoresponsive shape memory polymer can include first programming the two-way thermoresponsive shape memory polymer. The method may include cooling the two-way thermoresponsive shape memory polymer and subsequently re-shaping the two-way thermoresponsive shape memory polymer.

In some embodiments, programming the two-way thermoresponsive shape memory polymer includes heating the two-way thermoresponsive shape memory polymer to a temperature greater than the melting temperature of the polymer. In some embodiments, cooling the two-way thermoresponsive shape memory polymer includes cooling the two-way thermoresponsive shape memory polymer to a temperature of 20° C. or less.

In some embodiments, re-shaping may further include heating the two-way thermoresponsive shape memory polymer to a temperature of 60° C. or greater. The heating may cause the polymer to return to a semi-permanent position.

In some embodiments, the two-way thermoresponsive shape memory polymer may include an actuation magnitude of greater than 7.0%. In some embodiments, the two-way thermoresponsive shape memory polymer comprises a strain recovery of at least 49% when thermally cycled.

In some embodiments, programming the two-way thermoresponsive shape memory polymer may cause the polymer to orient in a first position. The first position may be linear. Cooling the two-way thermoresponsive shape memory polymer may cause the polymer to orient in a second position. The second position may be in a direction orthogonal to the first direction.

In some embodiments, the actuation of the two-way thermoresponsive shape memory polymer may be a freestanding two-way shape memory polymer gripping device.

Further aspects, objects, and advantages will become apparent upon consideration of the detailed description.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 is a flow diagram of a method for producing an actuator comprising a two-way thermoresponsive polymer in accordance with embodiments of the disclosure.

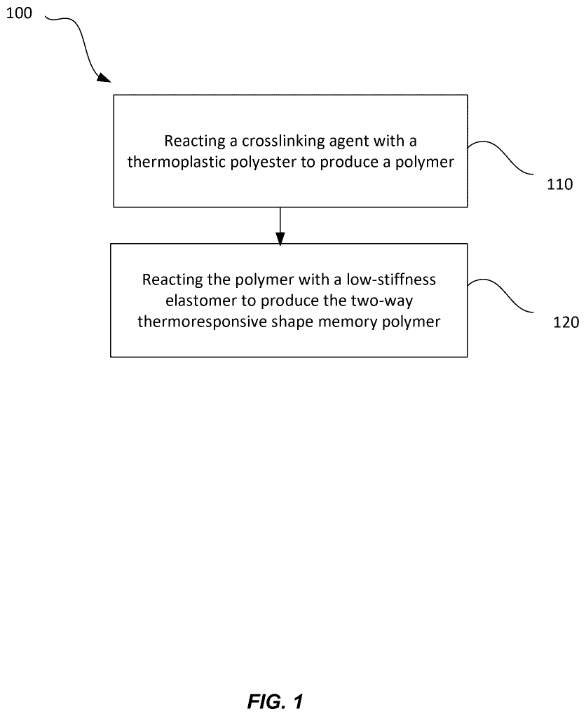

FIG. 2 is a flow diagram of a method of actuating a two-way thermoresponsive shape memory polymer in accordance with embodiments of the disclosure.

FIGS. 3A-3C provides a schematic (FIG. 3A) showing the programming of the two-way shape memory thermoresponsive polymer, and photographs of an example two-way thermoresponsive polymer cycle in a horizontal configuration (FIG. 3B) and in a vertical configuration (FIG. 3C) in accordance with embodiments of the disclosure.

FIGS. 4A-4D provides graphs of the two-way shape memory cycle of polycaprolactone (PCL)/dicumyl peroxide (DCP) as a two-way shape memory polymer (FIG. 4A), strain versus temperature cycles (FIG. 4B), a graph of four cycles demonstrating two-way shape memory behavior (FIG. 4C), and a schematic depicting the corresponding stages (FIG. 4D) in accordance with embodiments of the disclosure.

FIG. 5 provides photographs of an example two-way shape memory thermoresponsive polymer for use as a gripping device in accordance with embodiments of the disclosure.

### DETAILED DESCRIPTION OF THE INVENTION

Before the present disclosure is described in detail, it is to be understood that the terminology used herein is for purposes of describing particular examples and embodiments only, and is not intended to be limiting.

In this specification and in the claims that follow, reference will be made to a number of terms that shall be defined to have the following meanings:

As used herein, the terms “optional” or “optionally” as used herein mean that the subsequently described feature or structure may or may not be present, or that the subsequently described event or circumstance may or may not occur, and that the description includes instances where a particular feature or structure is present and instances where the feature or structure is absent, or instances where the event or circumstance occurs and instances where it does not.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Recitation of individual values herein are merely intended to serve as a method of referring to each separate value that can fall within a cited range. Unless otherwise indicated, all individual values may be extrapolated to provide a recitation of ranges that may include any value from the lowest value provided to the highest value provided. For example, if provided about 1, about 2, about 3, about 4, about 5, about 6, about 7, about 8, about 9, about 10, it is intended to also include ranges such as from about 1 to 10, from about 1 to 5 or from about 5 to 10. These are only examples of what is specifically intended, and all possible combination of numerical values between and including the highest value and the lowest value are to be considered to be recited in any combination of ranges.

The terms “about” and “approximately” as used herein shall generally mean an acceptable degree of error for the quantity measured given the nature or precision of the measurements. Exemplary degrees of error are within 20% (%); preferably, within 10%; and more preferably, within 5% of a given value or range of values. Any reference to “about X” or “approximately X” specifically indicates at least the values X, 0.95X, 0.96X, 0.97X, 0.98X, 0.99X, 1.01X, 1.02X, 1.03X, 1.04X, and 1.05X. Thus, expressions “about X” or “approximately X” are intended to teach and provide written support for a claim limitation of, for example, “0.98X.” Numerical quantities given herein are approximate unless stated otherwise, meaning that the term “about” or “approximately” can be inferred when not expressly stated. When “about” is applied to the beginning of a numerical range, it applies to both ends of the range.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition, in a description of a method, or in a description of elements of a device, is understood to encompass those compositions, methods, or devices consisting essentially of and consisting of the recited components or elements, optionally in addition to other components or elements. The invention illustratively described herein suitably may be practiced in the absence of any element, elements, limitation, or limitations which is not specifically disclosed herein.

Unless defined otherwise, all technical and scientific terms used herein have the same meaning as commonly understood by one of ordinary skill in the art to which this invention belongs. Although, any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

### Compositions

The present disclosure is directed to compositions for producing two-way shape memory polymers (SMP) based on a cross-linked polyester and a crosslinking agent. In some embodiments, the crosslinking agent is a peroxide, such as an organic peroxide. In some embodiments, the cross-linked polyester and the peroxide can be embedded in a low-stiffness elastomer. The composite structure may allow the SMP to undergo reversible shape transformations driven by temperature changes, without relying on external loads for actuation. The reversible shape change behavior may be referred to as a two-way SMP. In some embodiments, the composition described herein may be used for producing a freestanding two-way SMP griper that may undergo reversible shape transformations without the need for external forces or stress. For example, the compositions described herein may exhibit two-way shape memory behavior in a stress-free condition.

In some embodiments, the two-way shape memory polymer may include at least one polyester. The term “polyester” and other related terms, as used in this document, refer to a category of polymers that contain ester functional groups in their main chain. Various types of polyesters (“PEs”) may be employed in the compositions of the SMP polymer, such as aliphatic or aromatic PEs. The terms “acrylate,” “polyacrylate,” “acrylic” and the related terms refer to polymers derived from acrylic acid and related compounds. The terms “lactone” and “carboxylic esters” and the related terms refer to cyclic esters that are formed by removing water between a carboxylic acid and an alcohol within the same molecule. The polyester describe herein may be derived from a lactone. For example, the polyester can include polycaprolactone (PCL). In some embodiments, the shape memory polymer can include more than one polyester. Additionally, or alternatively, the polyester may be a polyol polyester. Polyol polyesters may refer to polyesters having multiple (e.g., two or more) functional hydroxyl groups such as diols, triols, or tetrols. The polyesters described herein may alternatively be referred to as semicrystalline polymers. For example, a semicrystalline polymer can include polybutadiene, poly(ethylene-co-vinyl acetate), and polycaprolactone. Semicrystalline polymers may be polymers that have a highly ordered molecular structure. The highly ordered structure may allow for the polymer to have characteristics that make the polymer preferred in a shape memory polymer composition. For example, the polymers have sharp melting point allowing them to maintain shape until a specific amount of heat is absorbed. In some embodiments, the polyester used in the shape memory polymer may be a biodegradable polymer.

In some embodiments, the two-way shape memory polymer may include at least one polyurethane. The term “polyurethane” (PU) and related terms refer to co-polymers composed of organic units joined by carbamate links. While polyethylene and polystyrene may refer to single types of polymers, polyurethane may refer to a group of polymers. Polyurethanes may be produced from a wide range of starting monomers that result in a multitude of polymers within the same group. For example, polyisocyanates (meaning isocyanates that have multiple (two or more) isocyanate (NCO) groups on each molecule) and polyols (meaning compounds with multiple (two or more) functional hydroxyl groups), such as diols. Various types of polyisocyanates may be employed in PU formation. A PU polyaddition reaction proceeds via NCO groups of polyisocyanates and hydroxyl groups of polyols. In some embodiments, polyurethanes that may be suitable for inclusion into the disclosed compositions are waterborne dispersions of polycarbonate-based or polyester-based PU stabilized by hydrophilic centers. Additionally, the disclosed compositions may include PU's with “blocked” isocyanate components. The disclosed compositions can include more than one (two, three, four, etc.) type of PU, more than one (two, three, four, etc.) type of PUD, and more than one (two, three, four, etc.) type of isocyanate. In some embodiments, other polymers may be used to produce the polyurethane. In some embodiments, the polyurethane may provide elasticity and tunable mechanical properties to the PCL matrix.

In some embodiments, the two-way shape memory polymer may include at least one polyether. The term “polyether” may refer to polymer compositions that are produced from monomers joined by ether linkages. For example, a polyether that may be used in the two-way shape memory polymer may be polyethylene glycol. In some embodiments, the polyethylene glycol (PEG) may also be referred to as polyethylene oxide (PEO) and poly(oxyethylene) (POE). In some embodiments, the PEG may impart tunable thermal properties when blended with PCL. In some embodiments, the PCL combination with PEG may result in dual-phase polymers with tailored glass transition temperatures (Tg) for reversible actuation of the two-way shape memory device as described herein. In some embodiments, the monomer may be an alkene that may undergo polymerization to produce cyclooctene. In some embodiments, the two-way shape memory polymer may be produced from crosslinking polycyclooctene.

The shape memory polymer can include a polyester, a polyether, or a polyurethane in an amount of up to about 98 wt. % (e.g., up to 98 wt. %, from 1 wt. % to 98 wt. %, from 10 wt. % to 98 wt. %, from 35 wt. % to 98 wt. %, or from 50 wt. % to 98 wt. %). For example, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, about 25 wt. %, about 26 wt. %, about 27 wt. %, about 28 wt. %, about 29 wt. %, about 30 wt. %, about 31 wt. %, about 32 wt. %, about 33 wt. %, about 34 wt. %, about 35 wt. %, about 36 wt. %, about 37 wt. %, about 38 wt. %, about 39 wt. %, about 40 wt. %, about 41 wt. %, about 42 wt. %, about 43 wt. %, about 44 wt. %, about 45 wt. %, about 46 wt. %, about 47 wt. %, about 48 wt. %, about 49 wt. %, about 50 wt. %, about 51 wt. %, about 52 wt. %, about 53 wt. %, about 54 wt. %, about 55 wt. %, about 56 wt. %, about 57 wt. %, about 58 wt. %, about 59 wt. %, about 60 wt. %, about 61 wt. %, about 62 wt. %, about 63 wt. %, about 64 wt. %, about 65 wt. %, about 66 wt. %, about 67 wt. %, about 68 wt. %, about 69 wt. %, about 70 wt. %, about 71 wt. %, about 72 wt. %, about 73 wt. %, about 74 wt. %, about 75 wt. %, about 76 wt. %, about 77 wt. %, about 78 wt. %, about 79 wt. %, about 80 wt. %, about 81 wt. %, about 82 wt. %, about 83 wt. %, about 84 wt. %, about 85 wt. %, about 86 wt. %, about 87 wt. %, about 88 wt. %, about 89 wt. %, about 90 wt. %, about 91 wt. %, about 92 wt. %, about 93 wt. %, about 94 wt. %, about 95 wt. %, about 96 wt. %, about 97 wt. %, or about 98 wt. %.

In some embodiments, the two way shape memory polymer may include a crosslinking agent. The cross linking agent may be used to enhance the two-way shape memory effect with the polyester. The crosslinking agents for use in the two-way shape memory polymer may decompose upon heating to form free radicals. The free radicals can aid in creating covalent bonds between polymer chains which can initiate the crosslinking between the chains. The crosslinking can form a stable network that define the permanent shape of the polymer. The crosslinking agent may be efficient at forming free radicals under heat treatment further increasing the crosslinking of the polymer. The increased efficiency leads to a highly dense crosslinked polymer. In some embodiments, the crosslinking agent may be a peroxide, such as a dialkyl peroxide. In some embodiments, the peroxide may be dicumyl peroxide, benzoyl peroxide, 2,5-dimethyl-2,5-di(t-butylperoxy) hexane, or any combination thereof.

The shape memory polymer can include the crosslinking agent in an amount of up to about 10 wt. % (e.g., from 0.001 wt. % to 10 wt. %, from 0.01 wt. % to 8 wt. %, from 0.10 wt. % to 6 wt. %, from 1 wt. % to 10 wt. %, or from 2 wt. % to 5 wt. %). For example, about 0.001 wt. %, about 0.002 wt. %, about 0.003 wt. %, about 0.004 wt. %, about 0.005 wt. %, about 0.006 wt. %, about 0.007 wt. %, about 0.008 wt. %, about 0.009 wt. %, about 0.01 wt. %, about 0.02 wt. %, about 0.03 wt. %, about 0.04 wt. %, about 0.05 wt. %, about 0.06 wt. %, about 0.07 wt. %, about 0.08 wt. %, about 0.09 wt. %, about 0.10 wt. %, about 0.20 wt. %, about 0.30 wt. %, about 0.40 wt. %, about 0.50 wt. %, about 0.60 wt. %, about 0.70 wt. %, about 0.80 wt. %, about 0.90 wt. %, about 1 wt. %, about 2 wt. %, about 3 wt. %, about 4 wt. %, about 5 wt. %, about 6 wt. %, about 7 wt. %, about 8 wt. %, about 9 wt. %, or about 10 wt. %.

The two-way shape memory polymer may include an elastomer matrix. The shape memory polymer, produced from the polyester and the crosslinking agent, may be embedded internal to the elastomeric matrix. In some embodiments, the elastomeric matrix may be a low-stiffness elastomer. For example, a low stiffness elastomer may refer to a material that is capable of withstanding a large amount of deformation. Measuring the stiffness of an elastomer may be performed using a durometer. A durometer may include a metal truncated cone indenter, attached to a small spring. The cone is placed atop the elastomer and a load is applied to the metal truncated cone indenter. The elastomer, under load, will resist indentation and cause a deflection. The deflection relates to a 1-degree shore A. Thus, the stiffness of the elastomer material may be referred to by the shore A score. For example, a low stiffness elastomer may be an elastomer having a shore A score of less than 90, as measured on the Shore A scale. In some embodiments, the low stiffness elastomer may have a shore A scale of from 0 to about 90. For example, the low stiffness elastomer may have a Shore A scale of from about 0 to about 20, from about 20 to about 40, from about 40 to about 60, from about 60 to about 80, or from about 80 to about 90. The low stiffness elastomer matrix may be made of natural rubbers, polyurethanes, polybutadienes, silicones, neoprene, or any combination thereof. For example, the silicone elastomer may be room temperature vulcanizing, Smooth-Sil™, Dragon Skin™, or any combination thereof. In other such embodiments, the elastomer may be Ecoflex™ 00-30 Platinum Cure Silicone Rubber (Part A & B) as produced and manufactured by Smooth-On. In some embodiments, the modulus of the elastomer may be less than 1 MPa.

The shape memory polymer can include the low stiffness elastomer that may have the shape memory polymer embedded as a sheet within at least two sheets of the low stiffness elastomer. For example, the low stiffness elastomer matrix may have a thickness that is at least 2 times as thick as the SMP sheet. In some embodiments, the shape memory polymer to elastomer matrix ratio may be from 1:4 to 1:8. For example, from 1:4, 1:5, 1:6, 1:7 or 1:8. In some embodiments, the ratio of SMP to elastomer matrix may be selected at least in part on the stiffness of the elastomer. In some embodiments, the two-way SMP may have an elastic modulus of about 100 MPa.

In some embodiments, the polymer may be positioned between multiple layers of the elastomer matrix. In yet other embodiments, more than one polymer layer may be positioned between more than one elastomer matrix. Such compositions may be produced with at least 2 layers. For example, the composition may have from about 2 layers to about 10 layers (e.g., 2 layers, 3 layers, 4 layers, 5 layers, 6 layers, 7 layers, 8 layers, 9 layers, or 10 layers). In some embodiments, the polymer, produced from the polyester and the crosslinking agent, may be combined with the low stiffness elastomer to produce a single matrix. For example, the polymers may be mixed together to produce a network of polyester/crosslinking agent and the low-stiffness elastomer. In some embodiments, the SMP polymer layer may be positioned between 2 layers of the low stiffness elastomer. The elastomer may be poured over the SMP polymer layer and further cured to form two layers positioned above and below the SMP.

In some embodiments, the thermoresponsive SMP polymer as described herein may include other additives, filler, or reinforcing material. The additives, fillers, or reinforcing material can include metals, organics, ceramics, inorganic material, nano rods, nanoparticles, carbon black, carbon nanotubes, carbon nano-fibers, silicon carbide, nickel, iron oxide, and clay particles. The additives, fillers, or reinforcing material may be added to alter the properties of the thermoresponsive SMP. For example, adding carbon nano-materials, nickel, iron oxide and the like, can improve the electrical conductivity of the thermoresponsive SMP. Other such nanomaterials may include carbon nanofibers and graphene nanoparticles that may be added to further alter the electrical properties of the SMP. The altered characteristics may allow for the use of two-way thermoresponsive SMPs in areas such as robotics and space structures. In some embodiments, the additive, filler, or reinforcing material may be added in an amount of up to 20 wt. %. For example, the two-way SMP may include about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, or about 20 wt. %, by weight of the polymer composition. In some aspects, the additive, filler, or reinforcing material may be added in an amount from 1 to 30 wt. % (e.g., from 1 wt. % to 29 wt. %, from 2 wt. % to 20 wt. %, from 3 wt. % to 10 wt. %, from 1 wt. % to 10 wt. %, or from 1 wt. % to 8 wt. %).

### Method of Making

The present disclosure is similarly directed to a method 100 of generating the two-way shape memory polymer as an actuator. The method can include reacting 110 a crosslinking agent with a polyester to produce a polymer and subsequently reacting 120 the polymer with a low-stiffness elastomer to produce the two-way thermoresponsive shape memory polymer. The actuator may be transitioned from a first position to a second position by application of a high temperature and can be reversable from the second position back to the first position under application of a low temperature.

In a first step, the method 100 include reacting the crosslinking agent with a thermoresponsive polyester to produce a polymer. In some embodiments, the crosslinking agent may be a peroxide, such as a dialkyl peroxide. In some embodiments, the peroxide may be dicumyl peroxide, benzoyl peroxide, 2,5-dimethyl-2,5-di(t-butylperoxy) hexane, or any combination thereof. In some embodiments, the thermoresponsive polyester may be selected from polycaprolactone, polybutadiene, poly(ethylene-co-vinyl acetate), or any combination thereof.

The polyester and the crosslinking agent may be combined in a 20:1, 19:1, 18:1, 17:1, 16:1, 15:1, 14:1, 13:1, 12:1, 11:1, 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, or 1:10, 1:11, 1:12, 1:13, 1:14, 1:15, 1:16, 1:17, 1:18, 1:19, or 1:20 ratio of thermoresponsive polyester:crosslinking agent. In some embodiments, the polyester may be included in the composition from about 905 wt. % to about 98 wt. % and the crosslinking agent may be included in an amount of from about 1 wt. % to about 5 wt. %. The thermoresponsive polymer and crosslinking agent may be mixed at a temperature of from about 60° C. to 200° C. For example, the temperature may be at about 70° C., 80 C, 90° C., 100° C., 110° C., 120° C., 130° C., 140° C., 150° C., 160° C., 170° C., 180° C., 190° C., or 200° C. In some embodiments, the composition may be mixed at a temperature of about 70° C. to 90° C. In some embodiments, the heating may be performed while simultaneously mixing the sample under constant rotations per minute (RPM).

Subsequent to producing the polymer, the thermoresponsive SMP is reacted 120 with the low-stiffness elastomeric material. For example, the low stiffness elastomeric material may include natural rubbers, polyurethanes, polybutadienes, silicones, neoprene, or any combination thereof. In some embodiments, the low-stiffness elastomeric material is combined with the polymer such that the thermoresponsive SMP is embedded within the low-stiffness elastomer. The combined material may be used as described further below. The composite structure as described herein may allow the SMP to undergo reversible shape transformations solely driven by temperature changes, without relying on external loads for actuation.

### Properties

The two-way thermoresponsive shape memory polymer described herein can address aspects previously overlooked thereby allowing the material to exhibit its two-way shape memory behavior in a stress free condition. In some aspects, the two-way thermoresponsive shape memory polymer may reproducibly cycle between temporary configurations and more permanent configurations while maintaining high strain % during use. The composition described herein may be capable of actuation between the temporary position and the more permanent position

The two-way thermoresponsive shape memory polymer composition described herein may have an actuation magnitude of greater than 7%. For example, the actuation magnitude may be greater than 7%, greater than 8%, greater than 9%, greater than 10%, greater than 11%, greater than 12%, greater than 13%, greater than 14%, greater than 15%, greater than 16%, greater than 17%, greater than 18%, greater than 19%, greater than 20%, greater than 21%, greater than 22%, greater than 23%, greater than 24%, or greater than 25%.

In some embodiments, the two-way thermoresponsive shape memory polymer composition described herein may have a strain recovery of at least 49% (e.g., from 49% to 100%, from 49% to 95%, from 60% to 100%, or from 75% to 100%). For example, the strain recovery may be at least 49%, at least 50%, at least 51%, at least 52%, at least 53%, at least 54%, at least 55%, at least 56%, at least 57%, at least 58%, at least 59%, at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or 100% strain recovery. In some embodiments. The two-way thermoresponsive shape memory polymer composition described herein may have a strain recovery of at least 85%.

In some embodiments, the two-way thermoresponsive shape memory polymer composition described herein may experience a high strain recovery after multiple cycles. For example, the polymer composition may have a high strain recovery after at least one cycle, at least 2 cycles, at least 3 cycles, at least 4 cycles, at least 5 cycles, at least 6 cycles, at least 7 cycles, at least 8 cycles, at least 9 cycles, or at least 10 cycles. In some embodiments, the two-way thermoresponsive shape memory polymer composition may maintain at least a 49% strain recovery.

### Method of Using

The present disclosure is additionally directed to a method of actuating a two-way thermoresponsive shape memory polymer. The method can include programming the two-way thermoresponsive shape memory polymer, cooling the two-way thermoresponsive shape memory polymer, and re-shaping the two-way thermoresponsive shape memory polymer. In some embodiments, the two-way shape memory polymer composition described herein may be configured to be a freestanding two-way SMP gripping device. For example, the gripping device or actuation of the two-way shape memory polymer composition described herein may be employed in biomedical devices, robotic systems, and deployable space structures. Biomedical devices may include, for example, soft robotics systems for use in medical devices such as minimally invasive surgeries or assisted devices for individuals with limited mobility.

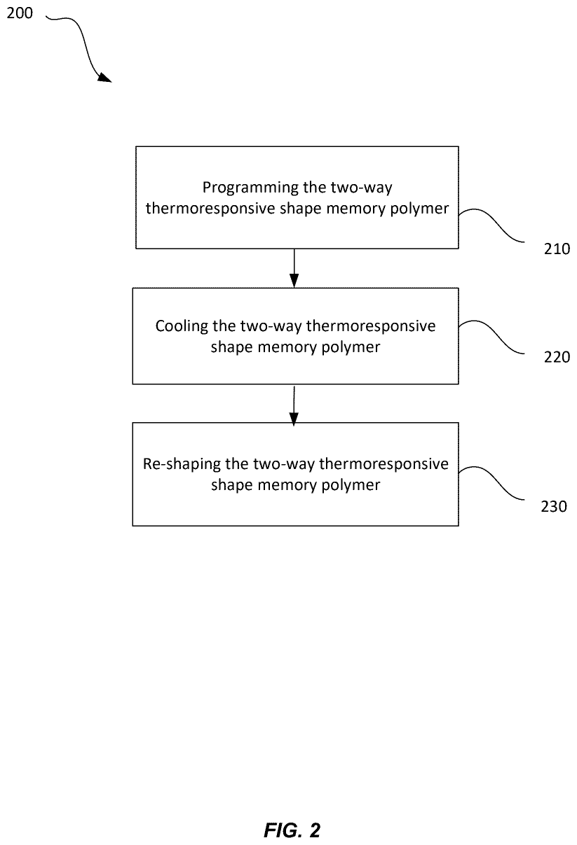

FIG. 2 provides a flow diagram for actuating 200 a two-way thermoresponsive shape memory polymer. The method includes an initial step of programming 210 the two-way thermoresponsive shape memory polymer. The programing 210 may include heating the polymer composition to a temperature of above the melting temperature of the polymer composition. In some embodiments, the temperature may be raised to above 40° C. (e.g., to above 45° C., above 50° C., above 55° C., above 60° C., above 65° C., above 70° C., above 75° C., or above 80° C.). For example, the temperature may be raised to about 40° C., about 41° C., about 42° C., about 43° C., about 44° C., about 45° C., about 46° C., about 47° C., about 48° C., about 49° C., about 50° C., about 51° C., about 52° C., about 53° C., about 54° C., about 55° C., about 56° C., about 57° C., about 58° C., about 59° C., about 60° C., about 61° C., about 62° C., about 63° C., about 64° C., about 65° C., about 66° C., about 67° C., about 68° C., about 69° C., about 70° C., about 71° C., about 72° C., about 73° C., about 74° C., about 75° C., about 76° C., about 77° C., about 78° C., about 79° C., or about 80° C. In some embodiments, the temperature for programming may be elevated to a temperature greater than 80° C. During heating, the increased mobility of the polyester chains may enable the material to transition to its permanent shape.

The programming may include heating the polymer composition to the above mentioned temperature under a constant load. For example, the constant load may be from about 1 N to about 5 N. The constant load applied may cause strain to increase as the polymer is stretched.

Once the polymer composition has been programmed, the two-way shape memory polymer composition may be cooled 220. The cooling temperature of the two-way shape memory polymer composition may be to a temperature of below the crystallization temperature of the polymer. In some embodiments, the polymer composition may be cooled to a temperature of below 40° C. For example, the composition may be cooled to below about 40° C., below about 39° C., below about 38° C., below about 37° C., below about 36° C., below about 35° C., below about 34° C., below about 33° C., below about 32° C., below about 31° C., below about 30° C., below about 29° C., below about 28° C., below about 28° C., below about 27° C., below about 26° C., below about 25° C., below about 24° C., below about 24° C., below about 23° C., below about 22° C., below about 20° C., or below about 20° C.

The cooling of two-way shape memory polymer composition may additionally be performed under constant load. For example, the constant load may be from about 1 N to about 5 N. The constant load applied may cause strain to increase as the polymer is stretched. The application of the constant load during cooling may further increase the elongation due to the formation of the crystalline phase and alignment of molecular chains, until reaching an upper strain plateau. The cooling may induce a conformational rearrangement that may allow for the temporary shape.

To complete that actuation of the two-way shape memory polymer composition may be re-shaped 230. “Re-shaping” or “shape recovery” may refer to the action of re-heating the two-way shape memory polymer composition. In some embodiments, the polymer composition may be re-heated to a temperature of greater than, or about, the melting temperature of the polymer composition. For example, the temperature may be raised to above 40° C., e.g., above 45° C., above 50° C., above 55° C., above 60° C., above 65° C., above 70° C., above 75° C., or above 80° C. In some embodiments, the temperature may be raised to about 40° C., about 41° C., about 42° C., about 43° C., about 44° C., about 45° C., about 46° C., about 47° C., about 48° C., about 49° C., about 50° C., about 51° C., about 52° C., about 53° C., about 54° C., about 55° C., about 56° C., about 57° C., about 58° C., about 59° C., about 60° C., about 61° C., about 62° C., about 63° C., about 64° C., about 65° C., about 66° C., about 67° C., about 68° C., about 69° C., about 70° C., about 71° C., about 72° C., about 73° C., about 74° C., about 75° C., about 76° C., about 77° C., about 78° C., about 79° C., or about 80° C. In some embodiments, the temperature for re-shaping may be elevated to a temperature greater than 80° C.

The re-shaping 230 of the two-way shape memory polymer composition may additionally be performed under constant load. For example, the constant load may be from about 1 N to about 5 N. The constant load applied may cause strain to increase as the polymer reaches the melting temperature. Subsequent to reaching the melting temperature, the strain may decrease (e.g., strain recover). For example, the re-shaping process may result in a strain reduction of about 6% on the polymer composition.

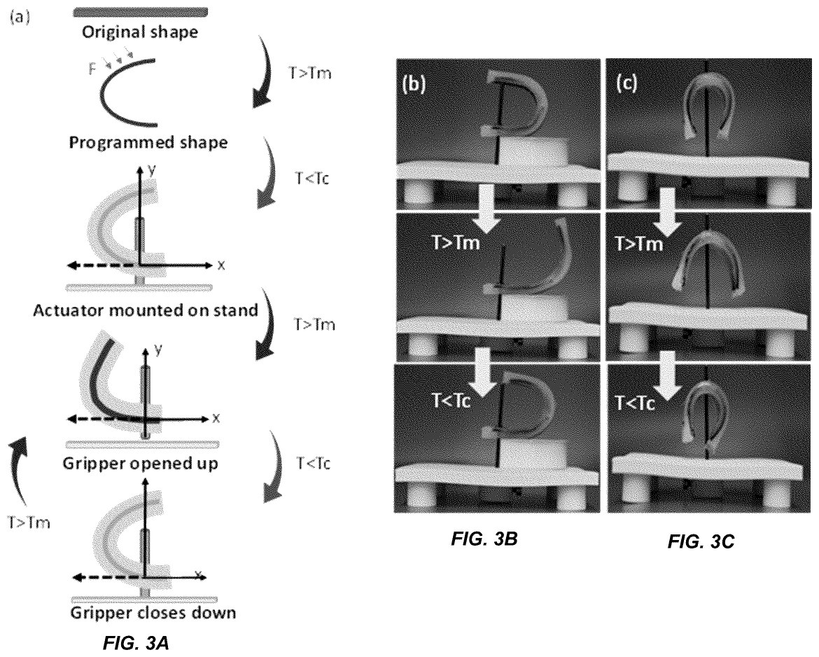

The actuation of the two-way shape memory thermoresponsive polymer may be better depicted in FIG. 3A. FIG. 3A provides a schematic representation of the actuation of a polymer composition as described herein. As depicted, the polymer composition may have a first orientation that may be linear. In some embodiments, the first orientation may be non-linear. A non-linear orientation may include a bent shape structure. A bent shape structure may refer to a material having at least one angle along the stretch of the material. For example, a linear material may include no angles, while bent may refer to a material having a 90 degree angle. In some embodiments, bent may refer to a U-shaped material wherein the two ends are parallel. It may be understood by those skilled in the art, polymer compositions described herein may have any first orientation configuration. Under temperature fluctuations, such as programming (e.g., increasing above the melting temperature) the first orientation may change to a second orientation. The second orientation may be referred to as a programmed shape. In some embodiments, the first orientation is different than the second orientation. For example, in a linear conformation as shown in FIG. 3A, the first orientation is linear. Subsequent to programming the polymer composition, the linear conformation may change to a non-linear conformation, such as a U-shape.

The programmed shape may be a non-linear configuration that may allow for further movement of the polymer as described herein. For example, after heating the polymer composition to above the melting temperature (Tm), the polymer composition may be cooled to a temperature below the crystallization temperature (Tc). The reduction in temperature may cause the polymer composition to further undergo elongation and reach a strain maximum. The elongation may increase the second orientation position, such as causing a linear shape to become a “U” shaped material wherein the first end and the second end, opposite the first end, may come together and physically touch. To re-shape the polymer (e.g., orient the polymer back into the first orientation) the composition may be heated a second time to above the melting temperature. The increase in temperature may allow for the polymer composition to alter its shape by further allowing an increase in entropy of the polymer chains. In some embodiments, the polymer chains may become more aligned under the crystallization temperature, thus allowing the actuator to fold further. The polymer composition may undergo repeated cycling allowing the polymer to act as an actuating device (e.g., opening and closing multiple times under alternated temperature stimuli).

In some embodiments, the two-way shape memory thermoresponsive polymer, as described herein, may be mounted to an anchor point. The anchoring may allow for the polymer composition to perform as a gripping device. For example, anchoring the polymer to a stand, shown in FIG. 3A, can allow for the polymer to fold along the Y-axis to form a closed loop on the stand. For example, the closing action of the polymer may allow for the ends positioned opposite one another to come together and provide a mechanical means of moving material. In some embodiments, the polymer composition described herein may be deployed as gripping devices in biomedical devices, including but not limited to, fingers, orthopedics, and other general medical applications. The gripping device may be used in aerospace and robotic systems where precise actuation and deformation on demand are characteristics.

### EXAMPLES

### Example 1: Production of a Two-Way Shape Memory Thermoresponsive Polymer

To produce a two-way shape memory strip as described herein, 5 grams of PCL pellets were fed into a preheated Thermo Scientific HAAKE minilab II microcompounder set to 80° C. After allowing a minimum of 5 minutes for temperature equilibrium throughout the chamber, the PCL pellets were melted and evenly dispersed into the twin screw extruder. Subsequently, 5% of DCP thermal cross-linker was added using a pipette and mixed with the PCL for 5 minutes at 60 rpm. The composition is mixed for a sufficient amount of time to ensure adequate mixing of the polymer and uniform dispersion of the peroxide without significant cross-linking induction. The mixture was then extruded into filament form using the microcompounder and allowed to cool to room temperature. The extruded filament was then cut into small strips and placed into a 1 mm thick mold. The strips were pressed between two hot plates, initially at 100° C. to melt and subsequently cured at 160° C. for 30 minutes under 100 PSI of pressure. After complete curing, the two-way shape memory polymer sheets were cooled to room temperature.

To fabricate the free-standing two-way shape memory polymer gripper, Ecoflex™ rubber was utilized as the low-stiffness elastomer. The Ecoflex™ rubber may impart various properties on the two-way SMP including, but not limited to, reasonable viscosity, soft, strong, and highly elastic, capable of being stretched many times larger than its original size without tearing. Additionally, the elastomer may quickly rebound to its initial form without any distortion, making it desirable for various applications. The matrix material for reinforcing the two-way SMP was synthesized by mixing Ecoflex™ rubbers in a 1A:1B weight ratio.

The actuator fabrication procedure consisted of five stages. At stage 1, the PCL/DCP and PCL/DHBP are prepared by cutting strips and heating the polymer matrix above its transition temperature at 70° C. Subsequently, the prepared two-way SMPs undergo shape programming by mechanically bending the two-way SMP to a configuration suitable for insertion into the mold. The bent strip is introduced into the mold and secured in a desired position until it cools to room temperature, facilitating the fixation of its shape. Once the position is cooled to room temperature, the synthesized matrix material may be poured into the mold, enveloping the two-way SMP programmed strips. The sample may then undergo a 24-hour curing process to solidify the matrix. Once cured, the free standing two-way SMP gripper may be extracted from the mold. Example 2: Performance of a two-way shape memory thermoresponsive polymer.

To better illustrate the performance characteristics, a polymer composition was produced as described above having a first orientation that is linear. The polymer composition was mounted to a stand in a horizontal configuration (FIG. 3B), and in a vertical configuration (FIG. 3C). The polymers were exposed to first temperature above the melting temperature of the polymer (e.g., 70° C., for 10 minutes). The exposure of the SMP to the temperature above the melting temperature causes the SMP to deform towards the second orientation (e.g., from pressing on the top portion of the stand in FIG. 3B, to opening or “releasing” as a gripping device). In the vertical orientation (FIG. 3C) the SMP becomes less “u” shaped and orients in a more linear direction. Cooling the SMP to a temperature below the crystallization temperature may cause the polymer to deform back towards the starting position. For example, the SMP, under cold temperatures, pressed back onto the stand (FIG. 3B). In the vertical orientation, the temperature below crystallization caused the SMP to re-orient the ends towards the stand, reorienting towards the “u” shape. The figures demonstrate the ability for the SMP to act as an actuator in both horizonal and vertical configurations. The figures further demonstrate the ability of the device to actuate under only external temperature alterations with no mechanical forces exerted on the SMP.

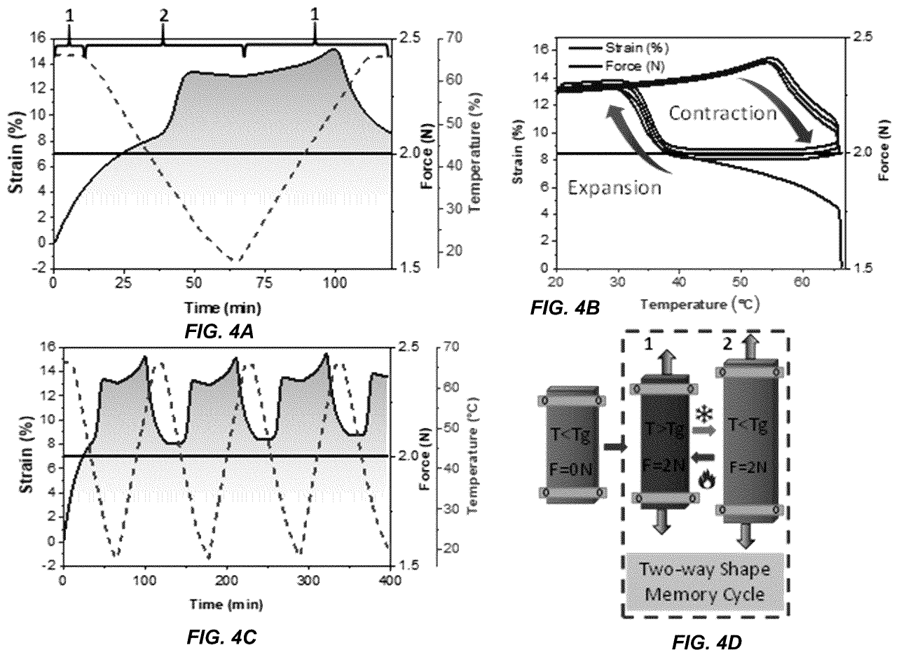

The two-way SMP behavior was further examined by applying cooling and heat cycles under constant stress conditions, covering a temperature range of from greater than the melting temperature to below the crystallization temperature. FIGS. 4A-4D provides graphs of the two-way shape memory cycle for polycaprolactone (PCL)/dicumyl peroxide (DCP) two-way shape memory polymer (FIG. 4A), strain versus temperature cycles (FIG. 4B), a graph of four cycles demonstrating two-way shape memory behavior (FIG. 4C), and a schematic depicting the corresponding stages (FIG. 4D) in accordance with embodiments of the disclosure. FIG. 4A demonstrates the two-way shape memory cycle exhibited by the PCL/DCP sample with the corresponding heating and cooling stages under constant applied load. For example, under constant load of 2 N, the SMP increased to about 14% strain when cooled, following heating the strain dropped to below 9%, demonstrating a high recovery magnitude of the SMP. FIG. 4 is a graphical representation of the strain (%) and the temperature (° C.) for the PCL/DCPS MP subjected to multiple cooling and heating cycles under the constant load. The data suggests that the two-way shape memory behavior is repeatable, as evidenced by the consistent strain-temperature patterns across multiple cycles. Notably, there is only a minor shift to higher strain values as the cycles progress, indicating stable performance and reliability of the SMP's shape memory properties over repeated thermal cycling.

The two-way shape memory behavior was evaluated based on the actuation magnitude, which denotes the elongation occurring during the cooling phase, and the recovery magnitude, which indicates the percentage of elongation recovered during the heating phase (FIG. 4C). During the initial cycle, the actuation magnitude was approximately 8.3%. The reversibility of the effect is demonstrated by a high recovery magnitude, which was 49% in the first cycle and 97% in the second cycle. FIG. 4C illustrates the two-way shape memory behavior over multiple cycles. After the initial cycle, the strain recovery remains consistently high, reaching up to 97% by the fourth cycle. This indicates that the sample exhibits excellent recoverability and demonstrates a robust two-way shape memory effect across repeated cycles. FIG. 4D provides a schematic depiction of the corresponding stages as discussed above. For example, at higher temperatures (stage 1) the temperature is above the glass transition temperature (Tg) and the force applies is at 2N. The SMP is cooled resulting in stage 2 wherein the temperature is below the glass transition temperature while maintaining constant load. Stage 2 may be re-heated to above the glass transition temperature again to return to stage 1.

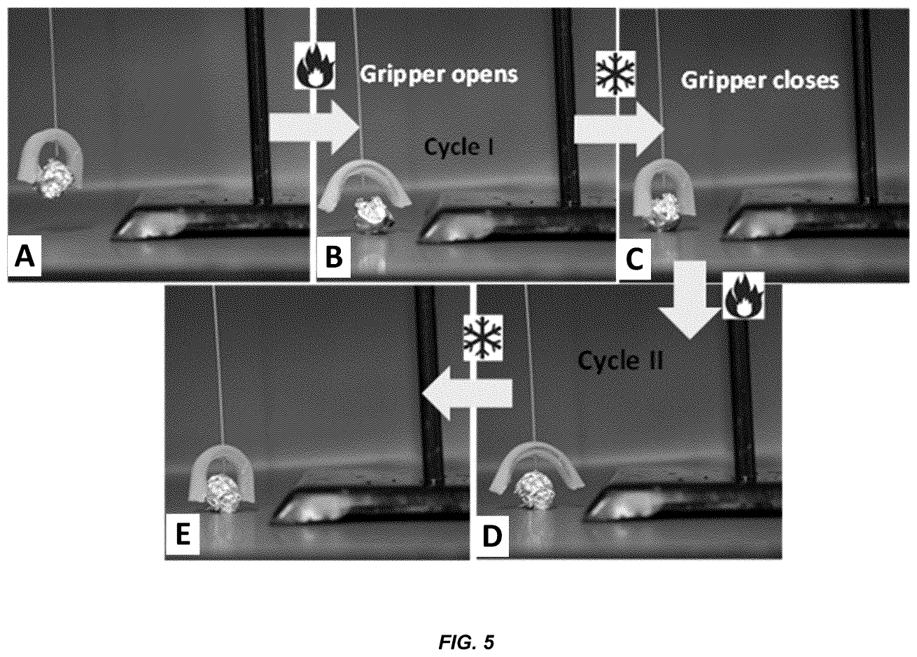

FIG. 5 provides photographs of an example two-way shape memory thermoresponsive polymer for use as a gripping device in accordance with embodiments of the disclosure. The functionality of the gripper is described above. Briefly, the actuation of the gripping device is controlled by heating and cooling the SMP to temperatures above the melting temperature and below the crystallization temperature. The gripping device was constructed by mounting the SMP to a metal rod by puncturing the rod though the center of a 1.5 cm by 7.0 cm SMP strip. In block A, the gripping device is securing a ball of aluminum foil and lifting it from the surface. The device is then heated, in block B, thereby causing the gripping action to release, or open, and the aluminum foil falls back onto the surface. The gripping device exhibited repeatable closing and opening responses during heating and cooling cycles, effectively illustrating the material's reversible shape transformations and recoverability over multiple actuation cycles (blocks C-E).

What is claimed is:

1. A thermoresponsive two-way shape memory polymer comprising:
a crosslinking agent;
a thermoplastic polyester; and
a low-stiffness elastomer, wherein the crosslinking agent and the thermoplastic polyester are positioned internal to the elastomer.

2. The thermoresponsive two-way shape memory polymer of claim 1, wherein the crosslinking agent is dicumyl peroxide and wherein the thermoplastic polyester is polycaprolactone.

3. The thermoresponsive two-way shape memory polymer of claim 1, wherein the low-stiffness elastomer comprises natural rubbers, polyurethanes, polybutadienes, silicones, neoprene, or any combination thereof.

4. The thermoresponsive two-way shape memory polymer of claim 1, wherein the thermoresponsive two-way shape memory polymer comprises an actuation magnitude of greater than 7.0%.

5. The thermoresponsive two-way shape memory polymer of claim 1, wherein the thermoresponsive two-way shape memory polymer comprises a strain recovery of at least 49% when thermally cycled.

6. The thermoresponsive two-way shape memory polymer of claim 1, wherein the thermoresponsive two-way shape memory polymer is configured to be a freestanding two-way SMP gripping device.

7. A gripping device comprising the thermoresponsive two-way shape memory polymer of claim 1.

8. A method of producing an actuator comprising a two-way thermoresponsive shape memory polymer comprising:
reacting a crosslinking agent with a thermoplastic polyester to produce a polymer;
reacting the polymer with a low-stiffness elastomer to produce the two-way thermoresponsive shape memory polymer, wherein the actuator is transitioned from a first position to a second position by application of a high temperature, and wherein the actuator is reversable from the second position back to the first position under application of a low temperature.

9. The method of claim 8, wherein the crosslinking agent is dicumyl peroxide.

10. The method of claim 8, wherein the thermoplastic polyester is polycaprolactone.

11. The method of claim 8, wherein the low-stiffness elastomer comprises natural rubbers, polyurethanes, polybutadienes, silicones, neoprene, or any combination thereof.

12. The method of claim 8, wherein the two-way thermoresponsive shape memory polymer comprises an actuation magnitude of greater than 7.0%.

13. The method of claim 8, wherein the two-way thermoresponsive shape memory polymer comprises a strain recovery of at least 49% when thermally cycled.

14. A method of actuating a two-way thermoresponsive shape memory polymer comprising:
programming the two-way thermoresponsive shape memory polymer;
cooling the two-way thermoresponsive shape memory polymer; and
re-shaping the two-way thermoresponsive shape memory polymer.

15. The method of claim 14, wherein programming the two-way thermoresponsive shape memory polymer comprises heating the two-way thermoresponsive shape memory polymer to a temperature greater than a melting temperature of the polymer.

16. The method of claim 14, wherein cooling the two-way thermoresponsive shape memory polymer comprises cooling the two-way thermoresponsive shape memory polymer to a temperature of 20° C. or less.

17. The method of claim 14, wherein the re-shaping further comprises:
heating the two-way thermoresponsive shape memory polymer to a temperature of 60° C. or greater, wherein the heating causes the polymer to return to a semi-permanent position.

18. The method of claim 14, wherein the two-way thermoresponsive shape memory polymer comprises an actuation magnitude of greater than 7.0%.

19. The method of claim 14, wherein the two-way thermoresponsive shape memory polymer comprises a strain recovery of at least 49% when thermally cycled.

20. The method of claim 14, wherein programming the two-way thermoresponsive shape memory polymer causes the polymer to orient in a first position, wherein the first position is a linear position, and cooling the two-way thermoresponsive shape memory polymer causes the polymer to orient in a second position, wherein the second position is in a direction orthogonal to the first direction.

21. The method of claim 14, wherein the actuation of the two-way thermoresponsive shape memory polymer is a freestanding two-way shape memory polymer gripping device.
